(19) United States
(12) Patent Application Publication
(10) Pub. No.: US 2015/0293314 A1
(43) Pub. Date: Oct. 15, 2015

(54) Cable Structure With Improved Clamping Configuration

(71) Applicant: Molex Incorporated, Lisle, IL (US)

(72) Inventors: Barbara BYCZKIEWICZ, Woburn, MA (US); Brian Keith LLOYD, Maumelle, AR (US)

(73) Assignee: Molex Incorporated, Lisle, IL (US)

(21) Appl. No.: 14/248,503

(22) Filed: Apr. 9, 2014

(51) Int. Cl. G02B 6/38

(52) U.S. Cl. CPC G02B 6/3887

(57) ABSTRACT

A cable used in high speed applications contains four internal cables with two wire pairs in each cable. The internal cables are protected by only a conductive braided shield and are arranged in the cable adjacent each other. At least four non-conductive blanks are disposed in the gaps which occur between adjacent ones of the internal cables. The blanks serve to prevent the cable outer insulation from sagging into the gaps between the internal cables so that the cable has a substantially circular configuration.

### BACKGROUND OF THE PRESENT DISCLOSURE

The Present Disclosure relates generally to cable structures, and, more particularly, to a high speed cable structure with an improved clamping configuration.

The use of high speed data transmission cables is ever growing. As the need for connectivity increases, high speed cables are needed to provide connections between various devices, such as routers and switches, etc. A number of standards have been developed for data communication. One such standard is the Quad Small Form-factor Pluggable (QSFP) standard, which pertains to compact, hot-pluggable transceivers. It serves to provide an interface between high speed devices such as routers, motherboards, switches, media converters and the like and fiber optic data cables and devices.

QSFP cables typically include four SFP cables enclosed in a trunk cable. Such cables are typically manufactured by twist or binding four SFP cables together. The assembly of these four SFP cables into a unit is not accomplished with much precision and usually the resulting QSFP (or “trunk”) cable has a variable configuration, or cross-section) through its length. It is also unpleasant in sight. The lack of a uniform configuration creates problems in usage of the cable, especially in breakout applications where the QSFP cable is slit to expose the four internal SFP cables. It is desirable to house the breakout in a housing, and if the QSFP cable configuration is variable it is difficult to clamp the cable in the backshell of the housing. Oval-shaped cables will be pinched by a circular opening in the backshell with possible risk of damaging the internal SFP cables. Utilizing a non-circular opening for the backshell in order to accommodate a variable configuration cable creates its own problems if the backshell clamping opening is larger than the cable because the open areas around the cable will become a potential Electromagnetic Interference (EMI) passage.

The Present Disclosure is therefore directed to a cable structure particularly suitable for trunk cable, including QSFP trunk cable, applications.

### SUMMARY OF THE PRESENT DISCLOSURE

Accordingly, there is provided a data communications cable structure suitable for use in QSFP applications having a configuration substantially round to create beneficial contact with a backshell opening.

In accordance with an embodiment described herein, a plurality of SFP style cables are provided with one or more twisted pairs of wires extending lengthwise through the single cable. Each pair may be wrapped in a conductive foil such as an aluminum Biaxially-Oriented Polyethylene Terephthalate (BoPET) film, and a drain wire is associated with each pair and enclosed by the outer conductive foil. In the preferred embodiment, two twisted pairs are provided and subsequently enclosed in an outer conductive braid to form one of the internal SFP cables. Four of those internal cables are arranged in pairs, such that each cable occupies the corner of an imaginary box, or square. This structure, without anything more, would have a non-circular configuration and at best approximate an oval, inasmuch as the extent of the outer trunk cable insulation can form a catenary between contact, or tangent points on adjacent internal cables. A trunk cable with three internal cables would have an approximate triangular shape. Either of these configurations present difficulties in clamping the trunk wire in a backshell by way of undesirable EMI openings or pinching of the trunk cable insulation.

In order to provide a circular configuration to the finished QSFP cable, a plurality of inert, or insulative fillers or blanks are disposed between adjacent cables as well as in the middle of the cable. These blanks not only serve to orient the SFP cables in a proper placement within the outer cable insulation, but also to provide a point of contact for the outer insulation approximately midway between the centers of two adjacent, internal cables. In this manner, the blanks preferably contact the outer insulation and prevent the formation of a catenary between adjacent cables. Therefore, in cooperation with the internal cables, the fillers/blanks present a more rounded continuous circular profile between adjacent cables, so that when the outer insulative jacket is extruded over the SFP cables and the blanks, the resulting trunk cable maintains a substantially circular configuration.

The circular configuration of the trunk cable also provides a better means of securing the cable to the backshell. This is because, typically, the cables have a required retention force in the backshell. Accordingly, it would be difficult to obtain a good cable retention on a non-round cable assembly without doing damage to the cable.

These and other objects, features and advantages of the Present Disclosure will be clearly understood through a consideration of the following detailed description.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 illustrates a cross-sectional view of a QSFP trunk cable constructed in accordance with the Present Disclosure;

FIG. 2 is a cross-sectional view of a known trunk cable with three internal cables illustrating an approximate triangular outer configuration;

FIG. 3 is a cross-sectional view of a known trunk cable with four internal cables illustrating a non-circular outer configuration;

FIG. 4 is a cross-sectional view of a trunk cable with two internal cables constructed in accordance with the Present Disclosure;

FIG. 5 is a cross-sectional view of a trunk cable with three internal cables constructed in accordance with the Present Disclosure; and

FIG. 6 is an exploded view of a cable breakout housing which receives a trunk cable constructed in accordance with the Present Disclosure.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

As noted above, the Present Disclosure is directed to improving the outer configuration of multi-wire cables, resulting in a better fit of the cables in backshells. The Present Disclosure is described in terms of a data communications trunk cable utilized for QSFP applications, as it contains four internal SFP cables. However, the use of QFSP and SFP in the Present Disclosure is not intended to be limiting, and it is noted that the Present Disclosure finds applicability in other multi-wire data transmission cable applications. As used herein, the outer cable will be referred to as a “trunk” cable, while the cables that make up and are contained within the outer cable will be referred to as “internal” cables. Accordingly, the trunk cable contains multiple cables and each internal cable contains multiple wires.

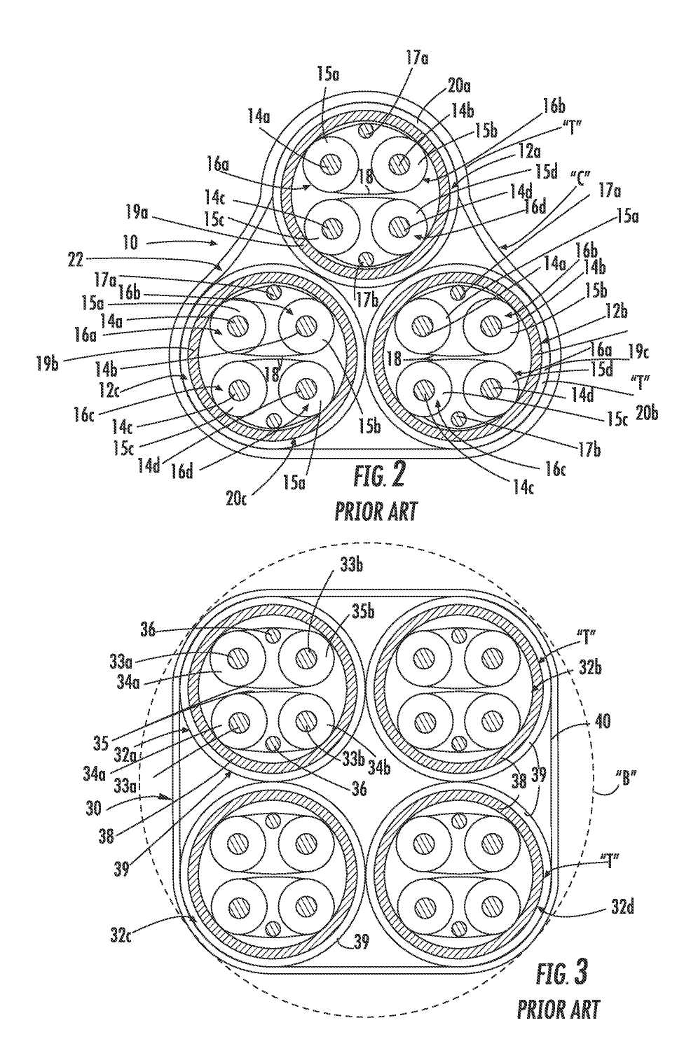

Turning now to FIG. 2, a known trunk cable structure 10 is illustrated. This trunk cable structure 10 includes three internal cables 12a-c. Each internal cable 12a-c is fashioned in the SFP style and thereby includes two pairs of conductors 14a-d that are surrounded by an outer extent of insulation 15a-d to define four wires 16a-d. The wires may be twisted along their length to form two twisted pair of wires and each wire pair is typically wrapped with an outer conductive foil 18. A drain wire 17a-b is associated with each wire pair. The three internal cables 12a-c are further structured with an outer conductive braid 19a-c and an outer insulation layer 20a-c that defines the outer diameter of the internal cables 12a-c.

The internal cables 12a-c are arranged adjacent each other to define the interior components of the trunk cable structure 10. An outer insulative covering 22 is provided that defines the outer diameter of the trunk cable structure 10. As depicted in FIG. 2, the outer perimeter, or cross-sectional configuration approximates a triangle and this is partly due to the catenary, or curve, “C” of the outer insulation that occurs between two tangent points “T” on adjacent internal cables 12a-c. If this trunk cable structure 10 is inserted into a backshell portion of a connector having a circular configuration (as shown in phantom in FIG. 2) there can be a risk of detrimental internal cable pinching if not oriented properly and there can appear openings through which EMI may leak.

Similarly, as shown in FIG. 3, which depicts a QFSP trunk cable 30 that contains four internal SFP-style cables 32a-d. Each internal cable 32a-d includes a pair of conductors 33a-b with surrounding insulation 34a-b and wrapped in a conductive film 35 to define two sets of wire pairs. Drain wires 36 extend within each wire pair and two wire pairs are enclosed within a conductive braid 38 and an outer insulative covering 39. The trunk cable 30 includes an outer insulative covering 40 that defines the outer diameter of the trunk cable 30. The outer insulation 40 of the trunk cable will either sag and form a catenary, or lie taut as shown in the area between two tangent points T where the internal cables 32b, 32d lie next to each other. The resulting outer configuration of this cable 30 is non-circular, or at best approximately a square and sometimes it can result in an oval configuration. As such, it cannot fit snugly within a circular opening of a backshell, as noted by the phantom line at “B.”

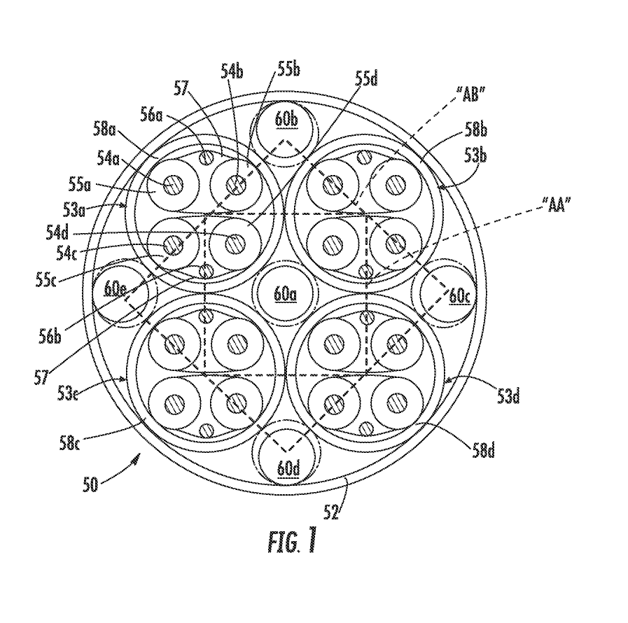

Turning now to FIG. 1, an improved trunk cable structure in accordance with the Present Disclosure is generally shown at 50. The trunk cable 50 includes an outer insulative covering 52 that defines a hollow passage extending the length and defining the diameter thereof. The hollow passage encloses a plurality of internal, SFP-style cables 53a-d. Each internal cable 53a-d has two wire pairs with conductors 54a-d surrounded by insulation layers 55a-d. The wire pairs preferably have drain wires 56a-b associated with them and one wire pair and an associated drain wire are enclosed by a conductive foil 57, preferably an aluminized BoPET foil to form an integrated wire pair. Two such wire pairs may be utilized in each internal cable as illustrated and are enclosed by an outer conductive braided shield 58a-d (preferably copper) and in a departure from conventional cable structures, no outer insulation covering is used over these braided shields 58a-d. The wire pairs are preferably arranged so that the conductors of each wire pair are aligned to form a row of conductors (in the horizontal direction in FIG. 1) and the conductors of different wire pairs are aligned to form a column of conductors (in the vertical direction of FIG. 1).

The internal cables 53 are arranged at corners of an imaginary four-sided figure such as a rectangle and preferably contact adjacent cables at locations P, although this is not shown for all four cables in FIG. 1. These internal cables have a given diameter and are arranged so that any one internal cable extends adjacent at least one other internal cable. The diameters of two adjacent cables serve to define a gap “G” therebetween which is disposed radially outwardly with respect to the centers of the internal cables. Likewise, a central passage is cooperatively defined by all the internal cables and disposed radially inwardly of the centers of the internal cables.

A plurality of fillers, or blanks, such as a fiber ropes or inert plastic rods 60a-e are provided to fill out the open areas within the trunk cable 50 that occur between adjacent internal cables 53. Preferably, one of the blanks 60a is disposed at the center of the trunk cable 50 and extends through the central passage thereof with the four internal cables 53a-d disposed around it. Preferably, as shown in phantom in FIG. 1, this center blank 60a makes contact with each one of the four surrounding internal cables 53. Four other blanks 60b-d are provided and each one of these remaining blanks 60b-d is disposed between each pair of two adjacent internal cables 53. The centers of the internal cables may be connected with imaginary lines as shown to form a four-sided figure “AA” and the centers of the four outer blanks 60b-d may be likewise connected with imaginary lines to form an additional four-sided figure “AB” that, as shown in FIG. 1, is angularly disposed with respect to the first imaginary figure and which intersects with the centers of the internal cables 53. The four-sided AA figure can fit within the boundaries of the AB figure.

As shown in FIG. 1, each of the blanks 60a-d may have a diameter as shown in phantom that contacts the internal cables 53 and the inner surface of the trunk cable outer insulation 52, or it may have a smaller diameter, shown in solid line in FIG. 1 which permits some play between the blanks 60a-d and the cables 53 and insulation 52. In this regard, the presence of the blanks 60b-d prevents the formation of any catenary curves caused by the outer insulation sagging, or taut surfaces extending between tangent points T of adjacent cables and the presence of the center blank 60a prevents the internal cables 53 from moving excessively radially toward the center of the trunk cable 50. As such, the trunk cable 50 is provided with a more rounded and circular configuration than is available in the conventional cable structures, as illustrated in FIGS. 2-3. In usage, it has been found that utilizing internal cables 53 with wires having a 24 AWG and the conductive braided shields have a diameter of 3.78 mm and a tolerance of +/−0.20 mm result in trunk cables having a diameter of 10.50 mm, +/−0.20 mm, and the resulting trunk cable configuration varies from a perfect circle no more than about 5% to about 7%. Generally, the internal cable diameters should range from about 0.30 to about 0.45 of the diameter D of the trunk cable 50. In the arrangement illustrated in FIG. 1, any single internal cable is positioned adjacent two flanking internal cables and is spaced apart from the remaining fourth internal cable.

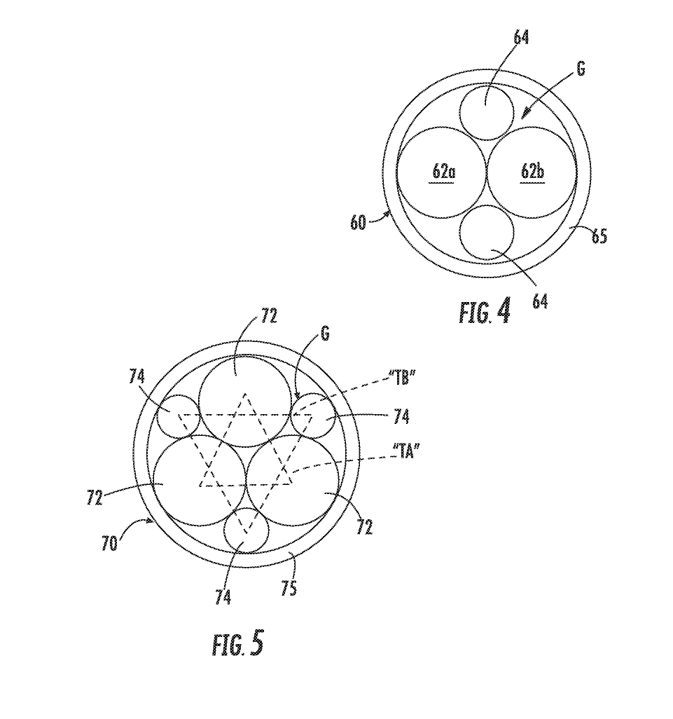

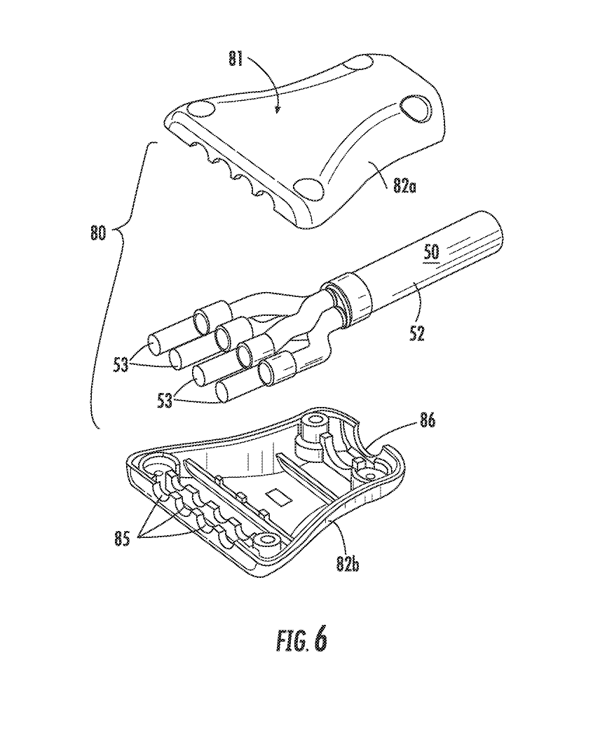

FIG. 4 illustrates a trunk cable 60 that utilizes two internal cables 62a-b of the SFP style shown and described above, each having two wire pairs. Two blanks 64 are provided for this trunk cable and are disposed in the gap G between adjacent internal cables so that preferably four points of contact are maintained against the outer insulative covering 65 of the trunk cable 60. The details of the wire arrangement within the internal cables of FIGS. 4-5 have been omitted for clarity, but they will be the same as those shown in FIG. 1.

FIG. 5 illustrates a trunk cable 70 that utilizes three internal cables 72 and three blanks 74 disposed in the gaps G between adjacent internal cables 72. A central blank is not shown in this three-wire configuration, but it will be understood that one may be used although it may necessitate one of a smaller diameter than the other blanks. The blanks 74 keep the outer insulation 75 from collapsing or sagging between adjacent cable and at the same time prevent the formation of straight, taut extents of insulation. In this particular embodiment, the centers of the internal cables may be connected by imaginary lines to form a first imaginary triangle “TA” and the centers of the blanks may be connected by imaginary lines to form a second imaginary triangle “TB.” As noted in FIG. 5 the imaginary triangles are inverted and most of the area of the TA triangle falls within the boundaries of the TB triangle.

FIG. 6 illustrates a breakout housing assembly 80 in which the housing 81 is comprised of two interengaging pieces 82a, 82b. The housing 81 accommodates the trunk cable 50 therein and has circular openings 85, 86 at its two ends that respectively accommodate the internal cables 53 and the trunk cable 50. The one opening 86 is circular and needs the trunk cable 50 to have a substantially circular configuration to fit properly therein. If the trunk cable configuration is excessively out of round, or non-circular, the sides of the housing may pinch the cable insulation 52 and break through and possibly damage the internal cables 53. Alternatively, if the configuration is non-circular, openings such as those shown in FIG. 3 may occur and these openings are points of leakage for EMI.

The blanks cooperate with the internal cables to increase the number of exterior contact points; i.e., points where the trunk cable outer insulation contacts the cables and blanks Increasing the number of potential contact points in cables such as those described above creates a more substantially circular configuration for the trunk cable 50 where the configuration does not deviate from a completely round circle by more than about 4.5% to about 7.5%

While a preferred embodiment of the Present Disclosure is shown and described, it is envisioned that those skilled in the art may devise various modifications without departing from the spirit and scope of the foregoing Description and the appended Claims.

What is claimed is:

1. A high speed trunk cable with an improved configuration, comprising:
an outer insulative covering, the outer insulative covering defining a lengthwise, hollow passage extending between two ends thereof;
a plurality of internal cables, each internal cables extending lengthwise through the trunk cable and between the two ends thereof, and including a least one wire pair, each wire of the wire pair including a center conductor and an outer insulation, the wire pair being enclosed in a conductive foil, the wire pair and conductive foil being further enclosed by an outer conductive shield, each internal cable being disposed in an arrangement within the hollow passage wherein one of the internal cables extends adjacent another one of the internal cables lengthwise through the trunk cable hollow passage; and
a plurality of non-conductive blanks, the blanks extending lengthwise through the trunk cable hollow passage, being disposed in gaps occurring between adjacent internal cables, and providing support for the trunk cable outer insulation covering in the gaps between adjacent internal cables such that the trunk cable outer insulation covering has a substantially circular configuration.

2. The high speed trunk cable of claim 1, further including four internal cables and at least four blanks, each cable being arranged such that any single internal cable is adjacent two of the four internal cables and spaced apart from one of the four internal cables.

3. The high speed trunk cable of claim 2, wherein the trunk cable has a diameter D and the internal cables have a diameter between about 0.30D to about 0.45D.

4. The high speed trunk cable of claim 3, wherein each blank contacts at least two adjacent internal cables.

5. The high speed trunk cable of claim 4, further including a fifth blank disposed at about the center of the trunk cable and between the internal cables.

6. The high speed trunk cable of claim 5, wherein the fifth blank contacts all the internal cables.

7. The high speed trunk cable of claim 2, wherein
imaginary lines drawn through centers of the four internal cables define a first imaginary four-sided figure; and
imaginary lines drawn through centers of the at least four blanks define a second imaginary four-sided figure, the first imaginary four-sided figure fitting within boundaries of the second imaginary four-sided figure.

8. The high speed trunk cable of claim 1, wherein the trunk cable includes two internal cables and two blanks, the blanks contacting opposing portions of adjacent internal cables.

9. The high speed trunk cable of claim 1, wherein the trunk cable includes three internal cables and three blanks, the centers of the internal cables and the blanks forming apices of two, inverted, imaginary triangles.

10. The high speed trunk cable of claim 1, wherein each internal cable includes two wire pairs, each wire pair being enclosed within a separate conductive foil.

11. The high speed trunk cable of claim 10, wherein centers of the conductors of each wire pair are arranged in rows and columns.

12. The high speed trunk cable of claim 10, wherein the trunk cable has a diameter D and the internal cables have diameters of between about 0.35D and about 0.45D.

13. The high speed trunk cable of claim 10, wherein the configuration of the trunk cable deviates from a perfect circle no more than about 4.5% and about 7.5%.

14. A trunk cable with an improved exterior configuration, comprising:
an outer insulative covering, the outer insulative covering defining a lengthwise, hollow passage extending between two ends thereof;
four internal cables, each internal cable extending lengthwise through the trunk cable and between the two ends thereof, and including a least one wire pair, each wire of the wire pair including a center conductor and an outer insulation, the wire pair being enclosed in a conductive foil, the wire pair and conductive foil being further enclosed by an outer conductive shield, each internal cable being disposed in an arrangement within the hollow passage wherein one of the internal cables extends adjacent another one of the internal cables lengthwise through the trunk cable hollow passage; and
at least four non-conductive blanks, the blanks extending lengthwise through the trunk cable hollow passage, being disposed in gaps occurring between adjacent internal cables;
wherein:
imaginary lines drawn through centers of the four internal cables define a first imaginary four-sided figure; and
imaginary lines drawn through centers of the at least four blanks define a second imaginary four-sided figure, the first imaginary four-sided figure fitting within boundaries of the second imaginary four-sided figure.

15. The trunk cable of claim 14, whereby the internal cables and the blanks provide support for the trunk cable outer insulation, enclosing them such that the trunk cable outer insulation covering has a substantially circular configuration.

16. The trunk cable of claim 14, wherein the trunk cable has a diameter D and the internal cables have diameters of between about 0.35D and about 0.45D.

17. The trunk cable of claim 14, wherein the configuration of the trunk cable deviates from a perfect circle no more than about 4.5% and about 7.5%.

18. A data communications cable with an improved exterior configuration, comprising:
four internal cables, each internal cable extending lengthwise and including first and second wire pairs, each wire of the wire pairs including a center conductor and an outer insulation, the wire pairs being enclosed by respective lengths of first and second conductive foil, and each internal cable further including an outer conductive shield that encloses the wire pairs therein, each internal cable being arranged so that each internal cable is adjacent another one of the internal cables lengthwise through the cable hollow passage such that gaps are disposed between adjacent internal cables radially outwardly from centers of the adjacent internal cables;
non-conductive blanks, the blanks extending lengthwise proximate the internal cables and respectively disposed in the gaps; and
an outer insulative jacket, the outer insulative jacket enclosing the internal cables and blanks, whereby the internal cables and blanks provide support for the cable outer insulation, enclosing them such that the cable outer insulation covering has a substantially circular configuration.

19. The cable of claim 18, wherein the configuration of the cable deviates from a perfect circle no more than about 4.5% and about 7.5%.

20. The cable of claim 19, wherein:
the internal cables define a central passage radially inwardly of their centers; and
a fifth blank extending lengthwise is disposed within the central passage.
